(19) United States
(12) Patent Application Publication
(10) Pub. No.: US 2009/0284585 A1
(43) Pub. Date: Nov. 19, 2009

(54) INTELLIGENT MULTI-VIEW DISPLAY SYSTEM AND METHOD THEREOF

(75) Inventors: Ya-Hui TSAI, Taoyuan County (TW); Tung-Chuan WU, Hsinchu City (TW); Wei-Han WANG, Taipei County (TW); Lai-Sheng CHEN, Hsinchu City (TW); Hsiao-Chun LU, Pingtung County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INDUSTRIAL TECHNOLOGY RESEARCH INSTITUTE, Hsin-Chu (TW)

(21) Appl. No.: 12/235,038

(22) Filed: Sep. 22, 2008

(30) Foreign Application Priority Data
May 15, 2008 (TW) 097117798

(51) Int. Cl. H04N 15/00

(52) U.S. Cl. 348/48; 348/E15.001

(57) ABSTRACT

An intelligent multi-view display system and an intelligent multi-view display method are disclosed. The system comprises at least a target object, at least an image capturing unit, and an image processing unit and an image displaying unit. The image capturing unit is capable of capturing images of the target object from arbitrary directions to generate image signals which are fed into the image processing unit where they are processed and sent to the image displaying unit for displaying the target object. Thereby, captured images of the target object are viewed from multiple directions.

### CROSS-REFERENCE TO RELATED APPLICATIONS

This non-provisional application claims priority under 35 U.S.C. §119(a) on Patent Application No. 097117798 filed in Taiwan, R.O.C. on May 20, 2008, the entire contents of which are hereby incorporated by reference.

### BACKGROUND OF THE INVENTION

1. Field of the Invention

The present invention generally relates to an intelligent multi-view display system and display method thereof and, more particularly, to an intelligent multi-view display system and an intelligent multi-view display method capable of displaying captured images of the target object from omni-directions.

2. Description of the Prior Art

A conventional photo is taken from a single view. However, if the photo is to be viewed from omni-directions, a plurality of photos are required to be taken from multiple directions. It takes plenty of time, cost, and energy. The modern digital photo frame is a fashionable digital photo display, which is only capable of displaying digital photos. E-commerce has been an inevitable and convenient way of shopping. Therefore, lots of corporations and persons are joining e-commerce as a major business, a sideline or a new opportunity. Photographing and display of products is thus very important for attracting attention from consumers on the Internet.

Therefore, there is great demand in providing a novel way of photographing and displaying products from a virtual three-dimensional photographing system with intelligent multi-view display to display captured images of a target object from a single camera or multiple cameras. For example, the digital photo frame is a potential candidate capable of interactively and dynamically displaying images with multiple viewpoints and can be widely used for personal purposes such as family photos, pet photos, couple photos, wedding photos or business purposes exhibition photos, e-commerce product photos, etc.

### SUMMARY OF THE INVENTION

The present invention is to provide an intelligent multi-view display system and an intelligent multi-view display method capable of displaying captured images of the target object from a single direction or multiple directions.

In order to achieve the foregoing object, the present invention provides an intelligent multi-view display system, comprising: at least a target object; at least an image capturing unit capable of capturing images of the target object from arbitrary directions to generate image signals; an image processing unit capable of processing the image signals generated by the image capturing unit; an image displaying unit capable of displaying the image signals processed by the image processing unit; and a sensor capable of sensing the rotating angle or the position of the image displaying unit to issue a sensed signal to the image processing unit to control the image processing unit to output an image with a corresponding view angle.

In order to achieve the foregoing object, the present invention provides an intelligent multi-view display method, comprising steps of: using at least an image capturing unit to capture images of at least a target object from arbitrary directions to generate image signals; using an image processing unit to process the image signals generated by the image capturing unit; using an image displaying unit to display the image signals processed by the image processing unit; and using a sensor to sense the rotating angle or the position of the image displaying unit to issue a sensed signal to the image processing unit to control the image processing unit to output an image with a corresponding view angle.

### BRIEF DESCRIPTION OF THE DRAWINGS

The objects, spirits and advantages of several embodiments of the present invention will be readily understood by the accompanying drawings and detailed descriptions, wherein:

FIG. 1 is a schematic diagram of an intelligent multi-view display system according to the present invention;

FIG. 2 is a schematic diagram showing image capturing units capturing images of a target object according to one embodiment of the present invention;

FIG. 3 shows the images captured from arbitrary directions according to the embodiment in FIG. 2;

FIG. 4 shows the images from arbitrary directions by rotating an image displaying unit;

FIG. 5 to FIG. 8 are schematic diagrams showing image capturing unit(s) capturing images of target object(s) according to other embodiments of the present invention; and

FIG. 9 is a flowchart of a process performed by image processing software according to the present invention.

### DETAILED DESCRIPTION OF THE PREFERRED EMBODIMENT

The present invention can be exemplified by the preferred embodiments as described hereinafter.

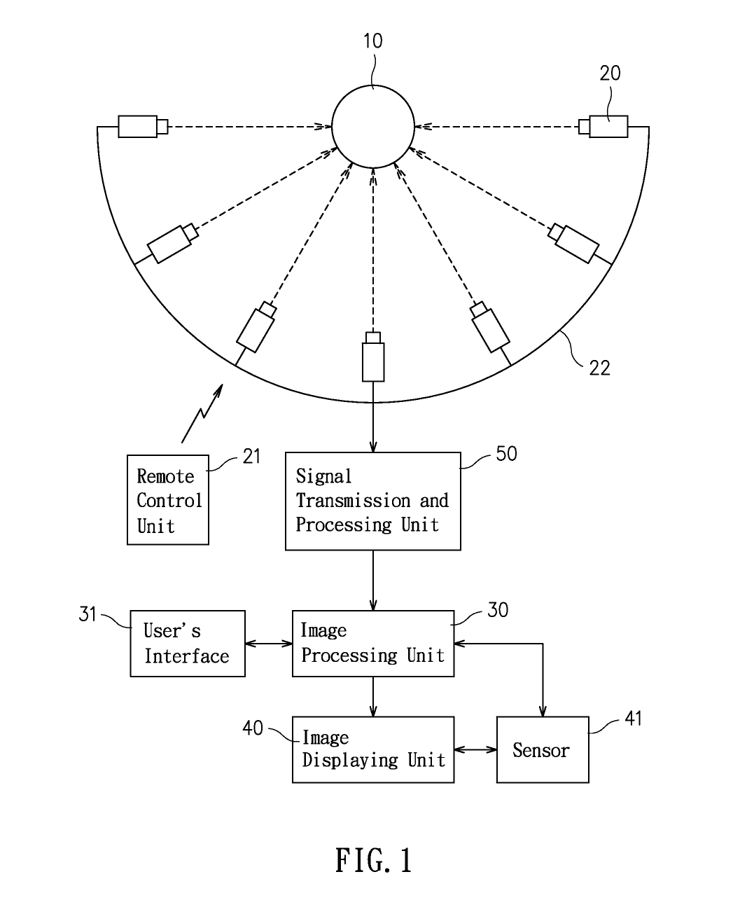

Please refer to FIG. 1, which is a schematic diagram of an intelligent multi-view display system according to the present invention. The intelligent multi-view display system comprises a target object 10, a plurality of image capturing units 20, an image processing unit 30 and an image displaying unit 40. The image capturing units 20 comprise conventional cameras, digital cameras or digital video cameras, capable of capturing images of the target object 10. The plurality of image capturing units 20 connect with a signal transmission and processing unit 50 through a transmission cable 22. The signal transmission and processing unit 50 is electrically connected to the image processing unit 30 and capable of receiving image signals generated by the image capturing unit 20 and transmitting the image signals to the image processing unit 30 where they are processed and sent to the image displaying unit 40 for displaying the target object 10. The image displaying unit 40 can be a digital photo frame or a display panel. Moreover, the image displaying unit 40 is used with a sensor 41 electrically connected to the image processing unit 30 and image displaying unit 40 to sense the rotating angle or the position of the image displaying unit 40. The sensor 41 issues a sensed signal to the image processing unit 30 to control the image processing unit 30 to output an image with a corresponding view angle to the image displaying unit 40. In one embodiment, the sensor 41 is a rotation sensor. It is noted that the connections between the aforesaid elements are realized through wired or wireless communication. For example, in one embodiment, the transmission cable 22 can be replaced by using wireless communication. Moreover, in one embodiment, the image capturing unit 20 is electrically connected to a remote control unit 21 (as shown in FIG. 1). The remote control unit 21 controls the image capturing unit 20 to capture the images of the target object 10 through wired or wireless communication.

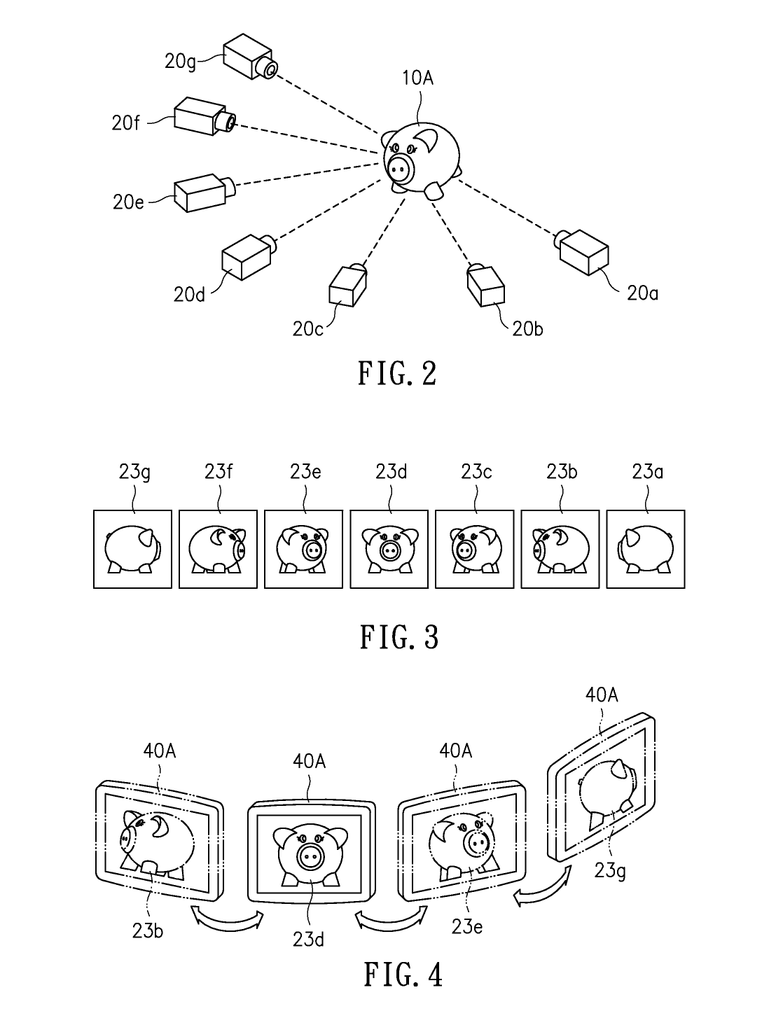

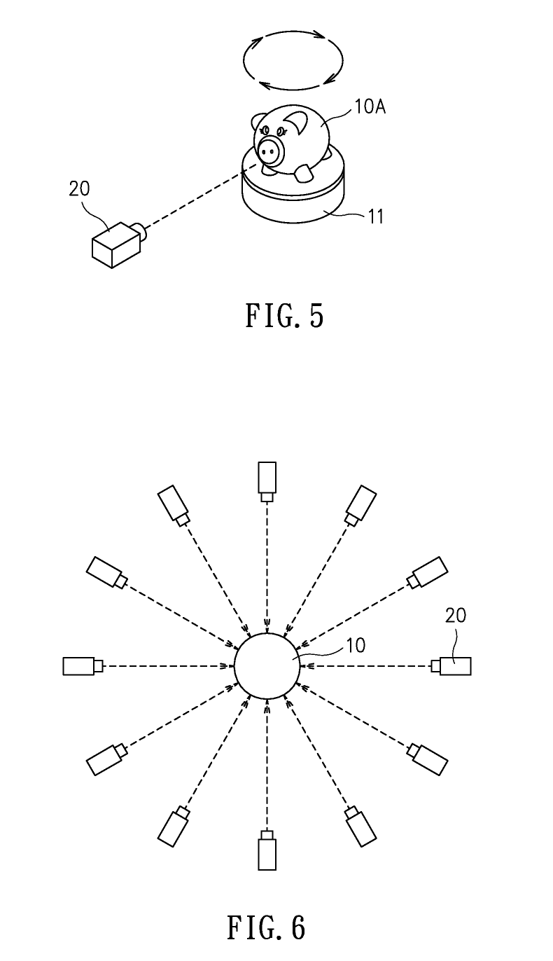

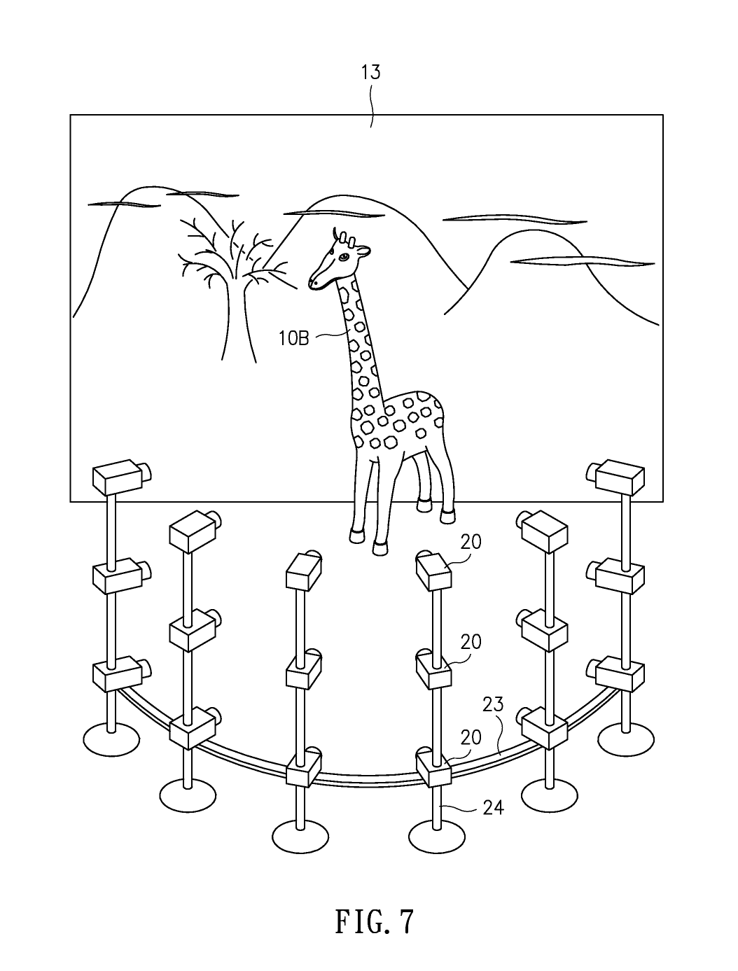

Please refer to FIG. 2, which is a schematic diagram showing image capturing units capturing images of a target object according to one embodiment of the present invention. As shown in FIG. 2, the plurality of image capturing units 20a to 20g are arranged in a fan-shaped region with an angle corresponding to a piglet (as a target object) 10A as a center. The plurality of image capturing units 20a to 20g being symmetric corresponding to the piglet 10A are distributed within an angle of 180 degrees. The distances between every two adjacent ones of the image capturing units 20a to 20g are identical and the heights of the image capturing units 20a to 20g are the same. The image capturing units 20a to 20g are controlled to synchronously capture the images of the piglet 10A from arbitrary directions to issue multi-view image signals. The multi-view image signals are then transmitted through the signal transmission and processing unit 50 (shown in FIG. 1) to the image processing unit 30 (shown in FIG. 1) where they are processed to generate images 23a to 23g with corresponding view angles as shown in FIG. 3. More particularly, the image 23a is captured on the left side of the piglet 10A by the image capturing unit 20a; the image 23d is captured in front of the piglet 10A by the image capturing unit 20d; the image 23g is captured on the right side of the piglet 10A by the image capturing unit 20g; and the images 23b, 23c, 23e, 23f the piglet 10A are captured from multiple directions by the image capturing units 20b, 20c, 20e, 20f. The images 23a to 23g are transmitted to and displayed on a digital photo frame 40A. As shown in FIG. 4, the digital photo frame 40A displays the image 23d. While the observer rotates the digital photo frame 40A for a certain angle towards left, the image 23b of the piglet 10A is displayed. Similarly, while the observer rotates the digital photo frame 40A for a certain angle towards right, the image 23e of the piglet 10A is displayed. If the digital photo frame 40A further rotates towards right, the digital photo frame 40A displays the image 23g of the piglet 10A. Thereby, virtual three-dimensional images are simulated. In another embodiment, the user can change parameters so that the image 23e of the piglet 10A is displayed while the observer rotates the digital photo frame 40A for a certain angle towards left. In other words, the user can rotate the digital photo frame 40A to view the piglet 10A from multiple directions.

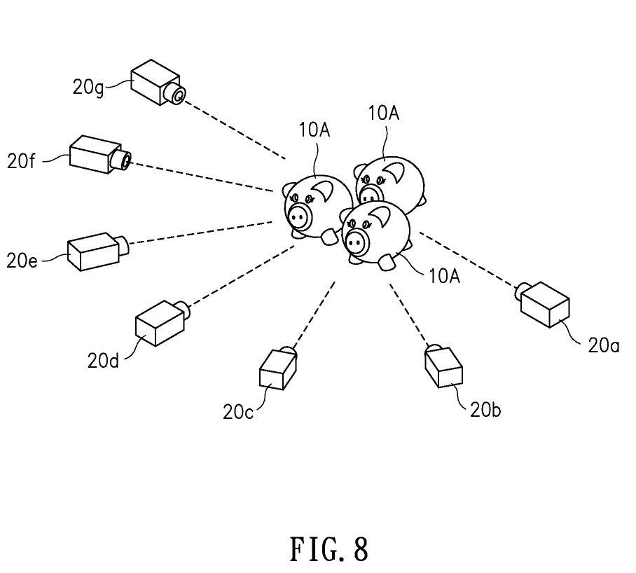

Referring to FIG. 5, the piglet 10A is disposed on a carrier 11 capable of rotating by 360 degrees to drive the piglet 10A to rotate by 360 degrees synchronously. Therefore, in the present embodiment, only one image capturing unit 20 is disposed. The rotating speed of the carrier 11 is determined and the image capturing unit 20 is controlled automatically or manually to capture images of the piglet 10A from arbitrary directions.

Referring to the embodiment in FIG. 6, the target object 10 is stationary. A plurality of image capturing units 20 are disposed around the target object 10. For example, twelve image capturing units 20 are controlled to capture twelve images of the target object 10 from arbitrary directions.

Referring to the embodiment in FIG. 7, a giraffe 10B (as a target object) is disposed with a background 13 behind the giraffe 10B and a frame 23 in front of the giraffe 10B. The frame 23 comprises a plurality of supporting elements 24. On each supporting element 24, there are three image capturing units 20 disposed in a vertical row. The present invention is exemplified by but not limited to the preferred embodiment. There can be a plurality of rows of image capturing units 20 to synchronously capture images of the giraffe 10B at different heights from arbitrary directions. Moreover, the supporting elements 24 are height adjustable so that the user can adjust the height of the supporting elements 24 to capture the images.

Please refer to the embodiment in FIG. 8, which is based on the embodiment in FIG. 2 except that there are three piglets 10A in the present embodiment. A plurality of image capturing units 20a to 20g are arranged in a fan-shaped region with an angle corresponding to the piglets 10A as a center. The plurality of image capturing units 20a to 20g being symmetric corresponding to the piglets 10A are distributed within an angle of 180 degrees. The image capturing units 20a to 20g are controlled to synchronously capture the images of the three piglets 10A from arbitrary directions to issue multi-view image signals. The multi-view image signals are then transmitted through the signal transmission and processing unit 50 (shown in FIG. 1) to the image processing unit 30 (shown in FIG. 1) where they are processed to generate images from arbitrary directions. Similarly, these three piglets 10A can also be disposed on the carrier 11 in FIG. 5, wherein the carrier 11 is capable of rotating by 360 degrees to drive the piglets 10A to rotate by 360 degrees synchronously. In this case, only one image capturing unit 20 is used. Alternatively, these three piglets 10A can also be disposed as in the embodiment in FIG. 6, wherein a plurality of image capturing units 20 are disposed around the three piglets 10A. Alternatively, these three piglets 10A are disposed with a frame 23 in front of them as shown in FIG. 7. The frame 23 comprises a plurality of supporting elements 24. On each supporting element 24, there are three image capturing units 20 disposed in a vertical row. Moreover, the supporting elements 24 are height adjustable so that the user can adjust the height of the supporting elements 24 to capture the images of the three piglets 10A from arbitrary directions.

Based on the intelligent multi-view display system in FIG. 1, the intelligent multi-view display method of the present invention comprises steps described hereinafter.

Step A: At least an image capturing unit 20 captures images of at least a target object 10 from arbitrary directions to generate image signals.

Step B: An image processing unit 30 processes the image signals generated by the image capturing unit 20.

Step C: An image displaying unit 40 displays the image signals processed by the image processing unit 30.

The image processing unit 30 processes the image signals using software. As shown in FIG. 1, the image processing unit 30 is connected to a user's interface 31. The user's interface 31 generally comprises a display panel, a keyboard and/or a mouse, through which the user is able to control the image processing unit 30. In other words, the software or the parameters in the image processing unit 30 is edited or determined to capture the images.

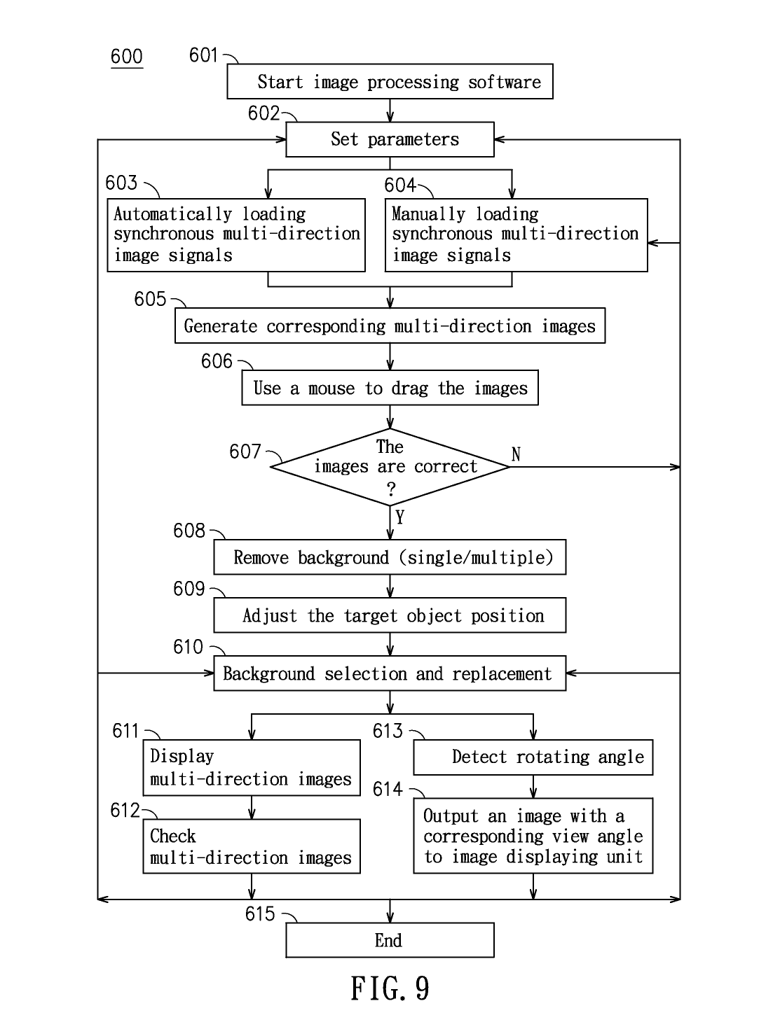

Please refer to FIG. 9, which is a flowchart of a process performed by image processing software in the image processing unit 30 according to the present invention. Also referring to FIG. 1, the process comprising steps of:

Step 601: The user starts an image processing software in the image processing unit 30 through the user's interface 31 after the intelligent multi-view display system is set up.

Step 602: The user sets parameters comprising the number of the image capturing units and the number of the multi-view images to synchronously capture the images of the target object 10 by the image capturing unit 20.

Step 603 and Step 604: The multi-view image signals are loaded into the image processing unit 30 automatically (Step 603) or manually (Step 604).

Step 605: The image processing unit 30 generates corresponding multi-view images according to received image signals.

Step 606: The user checks the images using the input device of the user's interface 31. For example, a mouse is conventionally used to drag the images. The images are updated according to the change of coordinates of the mouse.

Step 607: The user checks whether the images are correct, i.e., whether the images meet the user's requirement. Step 604 is performed again to load the multi-view image signals again and Step 605 to Step 607 are repeated until the images are correct if the images are not correct, otherwise the next step (Step 608) is performed if the images are correct.

Step 608, Step 609 and Step 610: The image signals are processed automatically by the image processing software or manually by the user using the through user's interface 31. The image processing steps comprise removing background of the target object (Step 608), adjusting the target object position (Step 609) and background selection and replacement (Step 610). More particularly, Step 608 and Step 610 can be performed for single or multiple images according to the user's demand. As shown in FIG. 7, the background 13 is processed by the image processing software to be removed or replaced with other background. It is noted that the background of the target object can be monochromatic or chromatic. When the background is monochromatic, the background can be removed or replaced automatically by the image processing software. When the background is chromatic (such as the non-monochromatic background in FIG. 7), the background can be removed or replaced manually by the user's interface 31 if the image processing software does not effectively removes or replaces the background.

Step 611: The images from multi-views are transmitted to be displayed on the user's interface 31 or the image displaying unit 40.

Step 612: The user checks the images from multi-views displayed on the user's interface 31 or the image displaying unit 40. Then the process goes to Step 602 to set the parameters to generate other multi-view images.

Step 613: The image displaying unit 40 is used with the sensor 41. The user rotates the image displaying unit 40 or disposes the image displaying unit 40 on a rotating platform. The sensor 41 senses the rotating angle or the position of the rotating platform, i.e., the rotating angle or the position of the image displaying unit 40 to transmit the sensed result to the image processing unit 30.

Step 614: The image processing unit 30 transmits the image with a corresponding view angle to the image displaying unit 40 according to the sensed angle or the position. For example, in FIG. 2 and FIG. 3, the image processing software is capable of analyzing the images 23a to 23g corresponding to different rotating angles of the image displaying unit 40 to effectively output the images.

Step 615: The process ends.

Accordingly, the intelligent multi-view display system and the intelligent multi-view display method of the present invention are capable of displaying captured images of the target object from a single direction or multiple directions. Moreover, multi-view images corresponding to different rotating angles of the image displaying unit are displayed so that the target object is shown interactively and dynamically. The present invention can be used for personal purposes such as family photos, pet photos, couple photos, wedding photos or business purposes exhibition photos, e-commerce product photos, etc. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An intelligent multi-view display system, comprising:
at least a target object;
at least an image capturing unit capable of capturing images of the target object from arbitrary directions to generate image signals;
an image processing unit capable of processing the image signals generated by the image capturing unit;
an image displaying unit capable of displaying the image signals processed by the image processing unit; and
a sensor capable of sensing the rotating angle or the position of the image displaying unit to issue a sensed signal to the image processing unit to control the image processing unit to output an image with a corresponding view angle.

2. The intelligent multi-view display system as recited in claim 1, wherein the target object is disposed on a carrier capable of rotating to drive the target object to rotate.

3. The intelligent multi-view display system as recited in claim 1, further comprising a plurality of image capturing units being capable of synchronously capturing images of the target object to generate multi-view image signals.

4. The intelligent multi-view display system as recited in claim 3, wherein the plurality of image capturing units are distributed in a fan-shaped region with an angle corresponding to the target object as a center.

5. The intelligent multi-view display system as recited in claim 4, wherein the plurality of image capturing units are equally-spaced distributed.

6. The intelligent multi-view display system as recited in claim 4, wherein the plurality of image capturing units are disposed at an identical height.

7. The intelligent multi-view display system as recited in claim 3, wherein the plurality of image capturing units are disposed on a supporting element with an adjustable height.

8. The intelligent multi-view display system as recited in claim 3, wherein the plurality of image capturing units are disposed in vertical rows.

9. The intelligent multi-view display system as recited in claim 8, wherein the plurality of image capturing units are equally-spaced distributed.

10. The intelligent multi-view display system as recited in claim 8, wherein the plurality of image capturing units are disposed in a plurality of rows distributed in a fan-shaped region with an angle corresponding to the target object as a center.

11. The intelligent multi-view display system as recited in claim 10, wherein the plurality of rows of image capturing units are equally-spaced distributed.

12. The intelligent multi-view display system as recited in claim 8, wherein the plurality of image capturing units are disposed on a supporting element with an adjustable height.

13. The intelligent multi-view display system as recited in claim 1, further comprising a remote control unit being capable of controlling the image capturing unit to capture the images of the target object.

14. The intelligent multi-view display system as recited in claim 1, further comprising a signal transmission and processing unit being capable of receiving the image signals generated by the image capturing unit and transmitting the image signals to the image processing unit.

15. The intelligent multi-view display system as recited in claim 14, wherein the signal transmission and processing unit and the image capturing unit are connected through wired or wireless communication.

16. The intelligent multi-view display system as recited in claim 1, wherein the image displaying unit is a digital photo frame or a display panel.

17. The intelligent multi-view display system as recited in claim 1, wherein the image processing unit comprises an image processing software being capable of processing the images captured by the image capturing unit while the images are virtual three-dimensional and controlling the image displaying unit to display two-dimensional images.

18. The intelligent multi-view display system as recited in claim 17, wherein the image processing unit comprises a user's interface being capable of enabling the user to control the image processing software and displaying the two-dimensional images.

19. An intelligent multi-view display method, comprising steps of:
using at least an image capturing unit to capture images of at least a target object from arbitrary directions to generate image signals;
using an image processing unit to process the image signals generated by the image capturing unit;
using an image displaying unit to display the image signals processed by the image processing unit; and
using a sensor to sense the rotating angle or the position of the image displaying unit to issue a sensed signal to the image processing unit to control the image processing unit to output an image with a corresponding view angle.

20. The intelligent multi-view display method as recited in claim 19, wherein the target object is disposed on a carrier capable of rotating to drive the target object to rotate.

21. The intelligent multi-view display method as recited in claim 19, further comprising a plurality of image capturing units being capable of synchronously capturing images of the target object to generate multi-view image signals.

22. The intelligent multi-view display method as recited in claim 21, wherein the plurality of image capturing units are distributed in a fan-shaped region with an angle corresponding to the target object as a center.

23. The intelligent multi-view display method as recited in claim 22, wherein the plurality of image capturing units are equally-spaced distributed.

24. The intelligent multi-view display method as recited in claim 22, wherein the plurality of image capturing units are disposed at an identical height.

25. The intelligent multi-view display method as recited in claim 24, wherein the plurality of image capturing units are equally-spaced distributed.

26. The intelligent multi-view display method as recited in claim 21, wherein the plurality of image capturing units are disposed on a supporting element with an adjustable height.

27. The intelligent multi-view display method as recited in claim 21, wherein the plurality of image capturing units are disposed in vertical rows.

28. The intelligent multi-view display method as recited in claim 27, wherein the plurality of image capturing units are equally-spaced distributed.

29. The intelligent multi-view display method as recited in claim 27, wherein the plurality of image capturing units are disposed in a plurality of rows distributed in a fan-shaped region with an angle corresponding to the target object as a center.

30. The intelligent multi-view display method as recited in claim 29, wherein the plurality of rows of image capturing units are equally-spaced distributed.

31. The intelligent multi-view display method as recited in claim 27, wherein the plurality of image capturing units are disposed on a supporting element with an adjustable height.

32. The intelligent multi-view display method as recited in claim 19, wherein the image capturing unit is a digital camera or a digital video camera.

33. The intelligent multi-view display method as recited in claim 19, further comprising a remote control unit being capable of controlling the image capturing unit to capture the images of the target object.

34. The intelligent multi-view display method as recited in claim 19, further comprising a signal transmission and processing unit being capable of receiving the image signals generated by the image capturing unit and transmitting the image signals to the image processing unit.

35. The intelligent multi-view display method as recited in claim 34, wherein the signal transmission and processing unit and the image capturing unit are connected through wired or wireless communication.

36. The intelligent multi-view display method as recited in claim 19, wherein the image displaying unit is a digital photo frame or a display panel.

37. The intelligent multi-view display method as recited in claim 19, wherein the image processing unit comprises an image processing software being capable of processing the images captured by the image capturing unit while the images are virtual three-dimensional and controlling the image displaying unit to display two-dimensional images.

38. The intelligent multi-view display method as recited in claim 37, wherein the image processing unit comprises a user's interface being capable of enabling the user to control the image processing software and displaying the two-dimensional images.

39. The intelligent multi-view display method as recited in claim 37, wherein the image processing software performs a process comprising steps of:
starting an image processing software;
setting parameters;
loading multi-view image signals;
generating corresponding multi-view images;
determining whether the images are correct;
loading the multi-view image signals again if the images are not correct, otherwise proceeding to the next step if the images are correct; and
performing an image process.

40. The intelligent multi-view display method as recited in claim 39, wherein the parameters comprises the number of the image capturing units and the number of the multi-view images.

41. The intelligent multi-view display method as recited in claim 39, wherein the multi-view image signals are loaded automatically or manually.

42. The intelligent multi-view display method as recited in claim 39, wherein the step of performing an image process comprises steps of:
removing the target object background;
adjusting the target object position; and
background selection and replacement.
